(19) United States
(12) Patent Application Publication
(10) Pub. No.: US 2025/0343001 A1
(43) Pub. Date: Nov. 6, 2025

(54) MULTILAYER CERAMIC ELECTRONIC COMPONENT AND ELECTRONIC DEVICE INCLUDING THE SAME

(71) Applicant: Samsung Electronics Co., Ltd., Suwon-si (KR)

(72) Inventor: Inyeol YUN, Suwon-si (KR)

(73) Assignee: Samsung Electronics Co., Ltd., Suwon-si (KR)

(21) Appl. No.: 18/918,579

(22) Filed: Oct. 17, 2024

(30) Foreign Application Priority Data
May 2, 2024 (KR) 10-2024-0058371

(51) Int. Cl. H01G 4/12; H01G 2/06; H01G 4/012; H01G 4/30

(52) U.S. Cl. CPC H01G 4/1227; H01G 2/065; H01G 4/012; H01G 4/30

(57) ABSTRACT

A multilayer ceramic electronic component includes a dielectric including a first surface, a second surface opposite the first surface, and side surfaces connecting the first surface and the second surface, and includes a plurality of stacked dielectric layers. The multilayer ceramic electronic component also includes an internal electrode in the dielectric, an external electrode penetrating the dielectric and the internal electrode, and a molding layer covering the first surface of the dielectric and the side surfaces of the dielectric. The second surface of the dielectric is at a different level than or at a same level as a lower surface of the molding layer.

### CROSS-REFERENCE TO RELATED APPLICATIONS

This U.S. non-provisional patent application claims priority under 35 U.S.C. § 119 to Korean Patent Application No. 10-2024-0058371, filed on May 2, 2024, in the Korean Intellectual Property Office, the entire contents of which are hereby incorporated by reference.

### BACKGROUND

Example embodiments of the inventive concepts relate to a multilayer ceramic electronic component and an electronic device including the same.

As electronic devices become smaller and higher in capacity, there is a demand for smaller and higher capacity electronic components used in the electronic device. One of these electronic components, a multilayer ceramic capacitor (MLCC), which is mounted on a printed circuit board of various electronic devices such as video equipment such as liquid crystal display (LCD) and plasma display panel (PDP), computers, and smart phones, plays a role in charging or discharging electricity. The multilayer ceramic capacitor may be used as a component of various electronic devices due to its small size and high capacity. Recently, in addition to miniaturizing and increasing the capacity of the multilayer ceramic capacitor, various studies have been conducted to improve reliability of the multilayer ceramic capacitor.

### SUMMARY

A multilayer ceramic component, according to some example embodiments of the inventive concepts, may include a dielectric including a first surface, a second surface opposite the first surface, and side surfaces connecting the first surface and the second surface. The dielectric includes a plurality of stacked dielectric layers. The multilayer ceramic component further includes an internal electrode in the dielectric, an external electrode penetrating the dielectric and the internal electrode, and a molding layer covering the first surface of the dielectric and the side surfaces of the dielectric. The second surface of the dielectric is at a different level than or at a same level as a lower surface of the molding layer.

A multilayer ceramic component, according to some example embodiments of the inventive concepts, may include a dielectric including a plurality of stacked dielectric layers, an internal electrode in the dielectric, an external electrode penetrating the dielectric and the internal electrode, a connection pad on the external electrode, and a molding layer on a plurality of surfaces of the dielectric. The connection pad and the molding layer are spaced apart from each other, and at least one surface of the plurality of surfaces of the dielectric does not include the molding layer.

An electronic device, according to some example embodiments of the inventive concepts, may include a package substrate, and a semiconductor chip and a multilayer ceramic electronic component on the package substrate and spaced apart from each other in a first direction parallel to an upper surface of the package substrate. The multilayer ceramic electronic component includes a dielectric including a plurality of stacked dielectric layers, an internal electrode in the dielectric, an external electrode penetrating the dielectric and the internal electrode, a connection pad on the external electrode and the dielectric, a connection terminal on the connection pad, and a molding layer on the dielectric. The molding layer covers a plurality of surfaces of the dielectric except for a surface including the connection pad.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a bottom view of a multilayer ceramic capacitor, according to some example embodiments of the inventive concepts.

FIG. 2 is a cross-sectional view taken along line A-A′ in FIG. 1.

FIG. 3 is a cross-sectional view taken along line A-A′ in FIG. 1 and illustrates another structure of the multilayer ceramic capacitor of FIGS. 1 and 2, according to some example embodiments of the inventive concepts.

FIG. 4 is a cross-sectional view showing an electronic device, according to some example embodiments of the inventive concepts.

FIGS. 5, 6, 7, 8, 9, and 10 are cross-sectional views showing operations in a manufacturing process of a multilayer ceramic capacitor, according to some example embodiments of the inventive concepts.

### DETAILED DESCRIPTION

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

It will be understood that when an element such as a layer, film, region, or substrate is referred to as being “on” another element, it may be directly on the other element or intervening elements may also be present. In contrast, when an element is referred to as being “directly on” another element, there are no intervening elements present. It will further be understood that when an element is referred to as being “on” another element, it may be above or beneath or adjacent (e.g., horizontally adjacent) to the other element.

Hereinafter, the terms “lower portion” and “upper portion” are for convenience of description and do not limit the positional relationship.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

A multilayer ceramic electronic components, according to example embodiments of the inventive concepts, may be or include an electronic component such as a capacitor, an inductor, a piezoelectric element, a varistor, or a thermistor that is composed of (or, otherwise, is manufactured using) a ceramic material. Hereinafter, for the purposes of discussion, example embodiments of the inventive concepts are described with reference to multilayer ceramic electronic components including a multilayer ceramic capacitor (MLCC). However, example embodiments are not limited thereto, and are equally applicable to other types of multilayer ceramic electronic components.

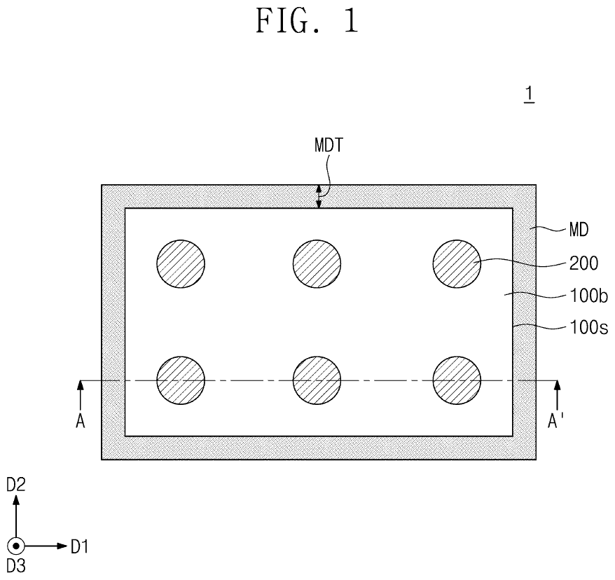

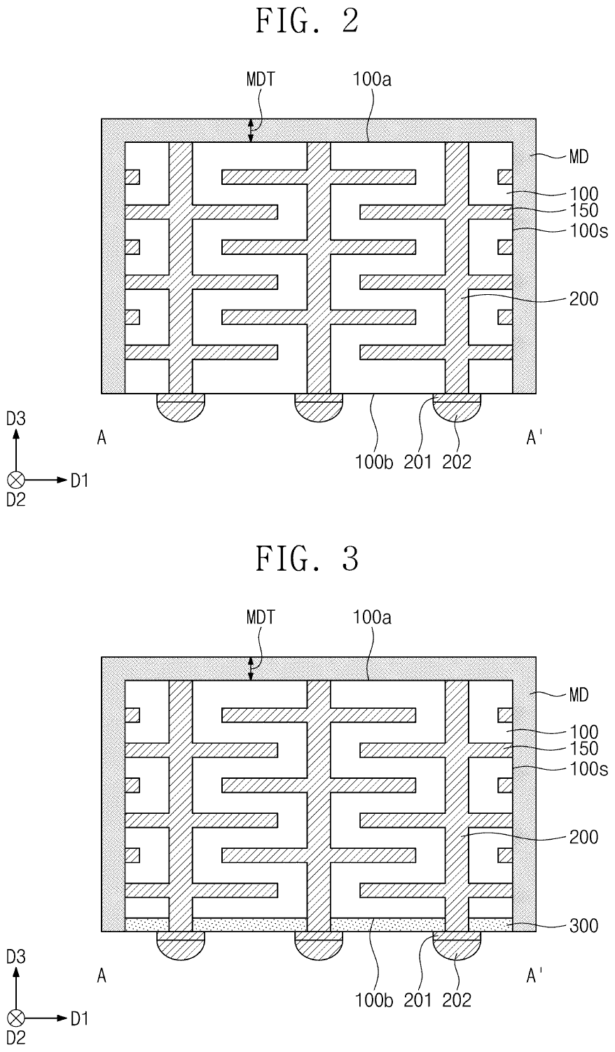

FIG. 1 is a bottom view of a multilayer ceramic capacitor 1, according to some example embodiments of the inventive concepts. FIG. 2 is a cross-sectional view taken along line A-A′ in FIG. 1. Referring to FIGS. 1 and 2, a multilayer ceramic capacitor 1 may include a dielectric 100, internal electrodes 150, external electrodes 200, and a molding layer MD.

For the purposes of discussion, a first direction D1 is defined as a direction parallel to an upper surface of the multilayer ceramic capacitor 1, a second direction D2 is parallel to the upper surface of the multilayer ceramic capacitor 1 and is defined as a direction perpendicular to the first direction D1, and a third direction D3 is defined as a direction perpendicular to the upper surface of the multilayer ceramic capacitor 1. The first direction D1, the second direction D2, and the third direction D3 are orthogonal to each other.

A dielectric 100 may include a plurality of dielectric layers stacked in the third direction D3. Boundaries of the dielectric layers may be visually indistinguishable. The dielectric 100 may include a first surface 100a, a second surface 100b, and side surfaces 100s integrally connected to the first surface 100a and the second surface 100b. A first surface 100a may correspond to an upper surface of the dielectric 100. A second surface 100b may correspond to a lower surface of the dielectric 100. In some example embodiments, the second surface 100b may be closer (adjacent or proximate) to a package substrate 10 (FIG. 4) than the first surface 100a.

The dielectric 100 may include a ceramic material having a high dielectric constant. As an example, the dielectric 100 may include barium titanate (BaTiO3) or strontium titanate (SrTiO3).

Internal electrodes 150 may be stacked in the dielectric 100. The internal electrodes 150 may include a conductive material. As an example, the internal electrodes 150 may include at least one of nickel (Ni), copper (Cu), and palladium (Pd).

External electrodes 200 may be provided penetrating the dielectric 100 and the internal electrodes 150. Multiple external electrodes 200 may be arranged along the first direction D1 and/or the second direction D2. Referring to FIG. 2, as illustrated, a lower surface of the external electrodes 200 may be substantially at a same level as the second surface 100b of the dielectric 100. The external electrodes 200 may include a conductive material. As an example, the external electrodes 200 may include at least one of nickel (Ni), copper (Cu), and palladium (Pd).

A molding layer MD may be formed on the dielectric 100 to cover at least some of the surfaces of the dielectric 100. The molding layer MD may cover (e.g., entirely cover) the first surface 100a of the dielectric 100 and the side surfaces 100s integrally connected to the first surface 100a. In some example embodiments, and as illustrated, the molding layer MD may not cover the second surface 100b. Referring to FIG. 2, a lower surface of the molding layer MD and the second surface 100b of the dielectric 100 may be substantially at a same level. One end of the external electrode 200, for example, in the third direction D3, may be in contact with the molding layer MD. A thickness MDT of the molding layer MD may be about 1 μm to about 100 μm.

The molding layer MD may be or include an insulating material such as an epoxy molding compound or an adhesive material.

First connection pads 201 may be disposed on the external electrodes 200 and the dielectric 100 on the second surface 100b. Each of the first connection pads 201 may be in electrical contact with respective one of the external electrodes 200. The molding layer MD does not cover the second surface 100b that may include the first connection pads 201, and the first connection pads 201 may be arranged spaced apart from the molding layer MD. Stated otherwise, the first connection pads 201 may not contact the molding layer MD. A thickness of the first connection pads 201 may be smaller than the thickness of the molding layer MD in the third direction D3. The first connection pads 201 may include a conductive material. For example, the first connection pads 201 may include copper (Cu).

First connection terminals 202 may be disposed on each of the respective first connection pads 201. The first connection terminals 202 may be or include an alloy including at least one or more of tin (Sn), silver (Ag), copper (Cu), nickel (Ni), bismuth (Bi), indium (In), antimony (Sb), or cerium (Ce).

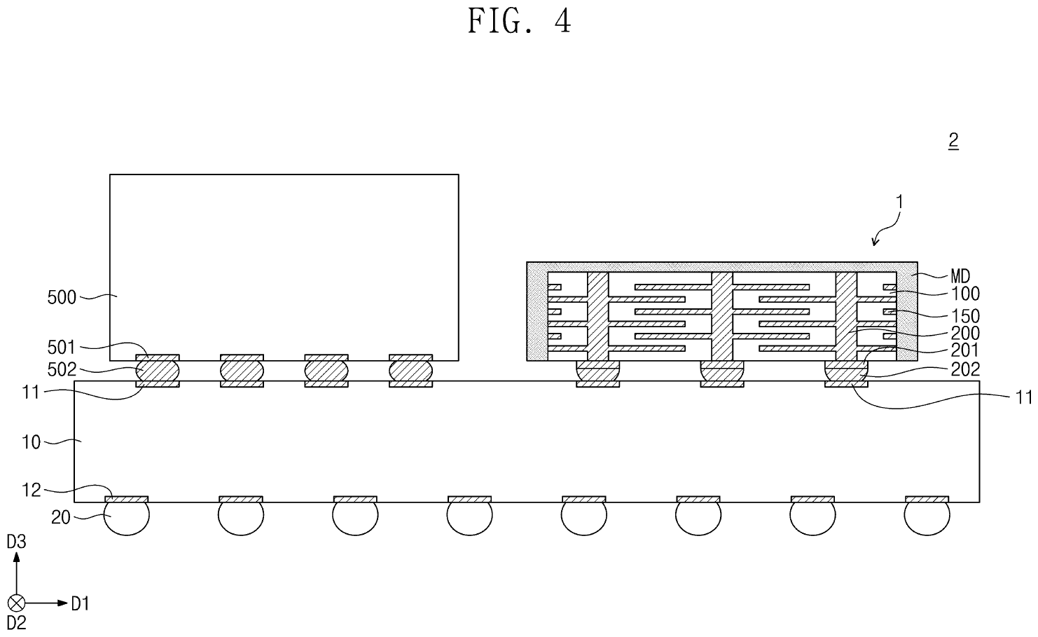

FIG. 3 is a cross-sectional view taken along line A-A′ in FIG. 1 to illustrate another structure of the multilayer ceramic capacitor of FIGS. 1 and 2, according to some example embodiments of the inventive concepts. The multilayer ceramic capacitor illustrated of FIG. 3 may be similar in some respects to the multilayer ceramic capacitor of FIGS. 1 and 2, and therefore may be best understood with reference thereto where like numerals indicate like elements not described again in detail.

Referring to FIG. 3, a protective layer 300 may be formed on the second surface 100b of the dielectric 100. An upper surface (with reference to the third direction D3) of the protective layer 300 may be at a higher level than the lower surface of the molding layer MD. A lower surface of the protective layer 300 may be substantially at a same level as the lower surface of the molding layer MD. The lower surface of the protective layer 300 may not be covered by the molding layer MD. The molding layer MD may be formed on and cover both side surfaces of the protective layer 300.

External electrodes 200 may penetrate the dielectric 100 and the protective layer 300 and may be in contact (e.g., electrical contact) with the first connection pads 201. The first connection pads 201 may be provided on a lower surface of the protective layer 300. The first connection pads 201 may be in contact (e.g., electrical contact) with the lower surface of the protective layer 300 and the external electrode 200. As the first connection pads 201 are provided on the protective layer 300 rather than the molding layer MD, adhesion of the first connection pads 201 may be improved. The protective layer 300 may include at least one of silicon nitride or silicon oxide.

FIG. 4 is a cross-sectional view showing an electronic device 2, according to some example embodiments of the inventive concepts. Referring to FIG. 4, an electronic device 2 may include a package substrate 10, a semiconductor chip 500 mounted on the package substrate 10, and the multilayer ceramic capacitor 1.

The package substrate 10 may be, for example, a printed circuit board (PCB). Alternatively, the package substrate 10 may have a structure in which insulating layers and wiring layers are alternately stacked. The package substrate 10 may include a plurality of first substrate pads 11 on an upper surface thereof and a plurality of second substrate pads 12 on a lower surface thereof.

External connection terminals 20 may be disposed on each of the respective second substrate pads 12. The external connection terminals 20 may be electrically connected to the package substrate 10, the semiconductor chip 500, and the multilayer ceramic capacitor 1 through the second substrate pads 12 and wiring paths in the package substrate 10.

The external connection terminals 20 may include solder balls or solder bumps. Depending on a type and an arrangement of the external connection terminals 20, the external connection terminals 20 may be provided in a form of a ball grid array (BGA), fine ball-grid array (FBGA), or land grid array (LGA). The external connection terminals 20 may be or include an alloy including at least one of tin (Sn), silver (Ag), copper (Cu), nickel (Ni), bismuth (Bi), indium (In), antimony (Sb), or cerium (Ce).

A semiconductor chip 500 may be disposed on the package substrate 10. The semiconductor chip 500 may be, for example, a logic chip or a memory chip. The semiconductor chip 500 may be, for example, one of a central processing unit (CPU), a graphics processing unit (GPU), an application specific integrated circuit (ASIC), DRAM, SRAM, and NAND FLASH. A plurality of chip pads 501 may be disposed on a lower surface of the semiconductor chip 500.

Second connection terminals 502 may be disposed between the semiconductor chip 500 and the package substrate 10. Each of the second connection terminals 502 may be interposed between the first substrate pads 11 and the chip pads 501 and may be in electrical contact with the first substrate pads 11 and the chip pads 501. The second connection terminals 502 may include a metal that is substantially the same as or similar to that of the external connection terminal 20. For example, the second connection terminals 502 may include tin (Sn), bismuth (Bi), lead (Pb), silver (Ag), or alloys thereof.

The multilayer ceramic capacitor 1 may be disposed on the package substrate 10. The multilayer ceramic capacitor 1 may be spaced apart from the semiconductor chip 500 in the first direction D1 such that a gap or space may be defined therebetween. The first connection terminals 202 may be disposed between the first connection pads 201 and the first substrate pads 11. Each of the first connection terminals 202 may be interposed between the first substrate pads 11 and the first connection pads 201 and may be in electrical contact with the first substrate pads 11 and the first connection pads 201.

The multilayer ceramic capacitor 1, according to example embodiments of the inventive concepts, may include the dielectric 100, the internal electrodes 150, the external electrodes 200 penetrating the internal electrodes 150, and the molding layer MD. The molding layer MD may cover the surfaces of the dielectric 100. As a result, water resistance or moisture resistance, along with thermal resistance and mechanical resistance, of the multilayer ceramic capacitor may be improved. The reliability of the multilayer ceramic capacitor may also be improved.

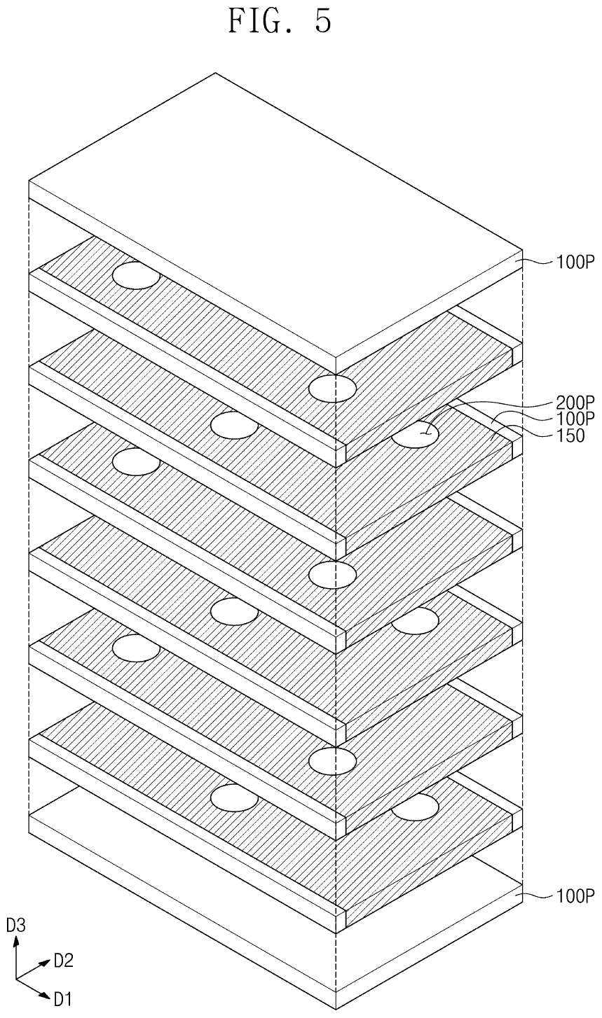

FIGS. 5, 6, 7, 8, 9, and 10 are cross-sectional views showing operations in a manufacturing process of a multilayer ceramic capacitor, according to some example embodiments of the inventive concepts.

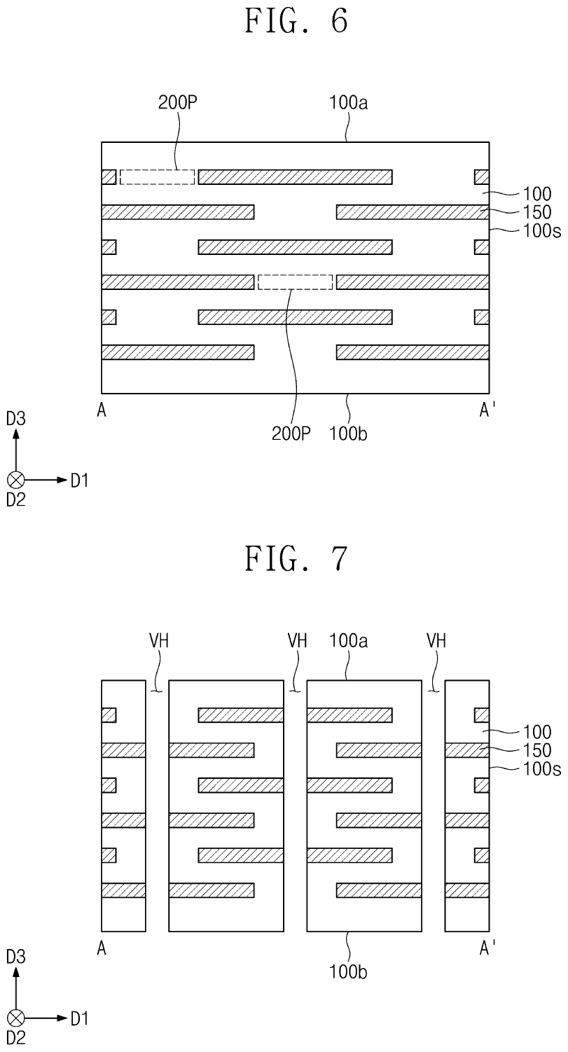

Referring to FIGS. 5 and 6, a plurality of sheets, each including a dielectric layer 100P having internal electrodes 150 formed thereon may be stacked sequentially in the third direction D3. For example, the internal electrodes 150 may be formed by applying a conductive paste on each dielectric layer 100P using a screen printing process. Some regions of the dielectric layer 100P may include non-printed regions 200P where the conductive paste is not applied.

Additional dielectric layers 100P may be stacked in the third direction D3 under the lowermost sheet of the plurality of sheets and on the uppermost sheet of the plurality of sheets. By cutting and firing the stacked sheets, a dielectric 100 including stacked dielectric layers 100P may be formed, as shown in FIG. 6. The dielectric 100 may include a first (or upper) surface 100a (extending in the first direction D1 and second direction D2) and a second (or lower) surface 100b (extending in the first direction D1 and second direction D2) facing away from each other, and side surfaces 100s (extending in the second direction D2 and the third direction D3) integrally connected to the first surface 100a and the second surface 100b.

Referring to FIG. 7, a plurality of via holes VH may be formed penetrating the dielectric 100 and the internal electrodes 150 in the locations of the non-printed regions 200P (FIGS. 5 and 6). The via holes VH may define a region where the external electrodes 200 (FIG. 2) may be formed. A size (or a cross-sectional area) of the via holes VH may be smaller than a size (or cross-sectional area) of the non-printed regions 200P (FIGS. 5 and 6).

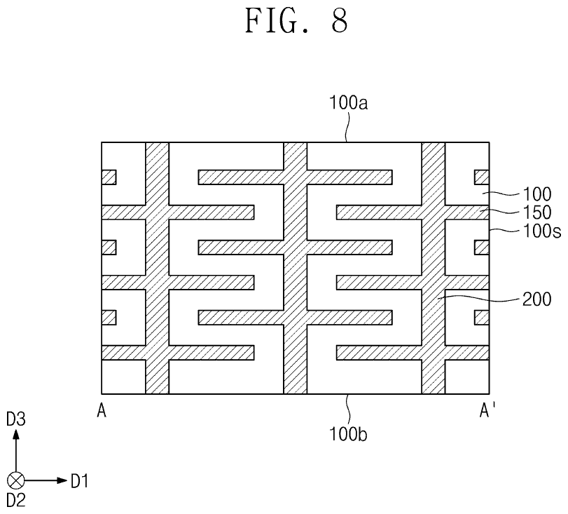

Referring to FIG. 8, external electrodes 200 may be formed by filling internal spaces of the via holes VH with a conductive material. In example embodiments, organic additives may be filled in the internal space of the via holes VH. Thereafter, the conductive materials filling the via holes VH may be dried to form the external electrodes 200.

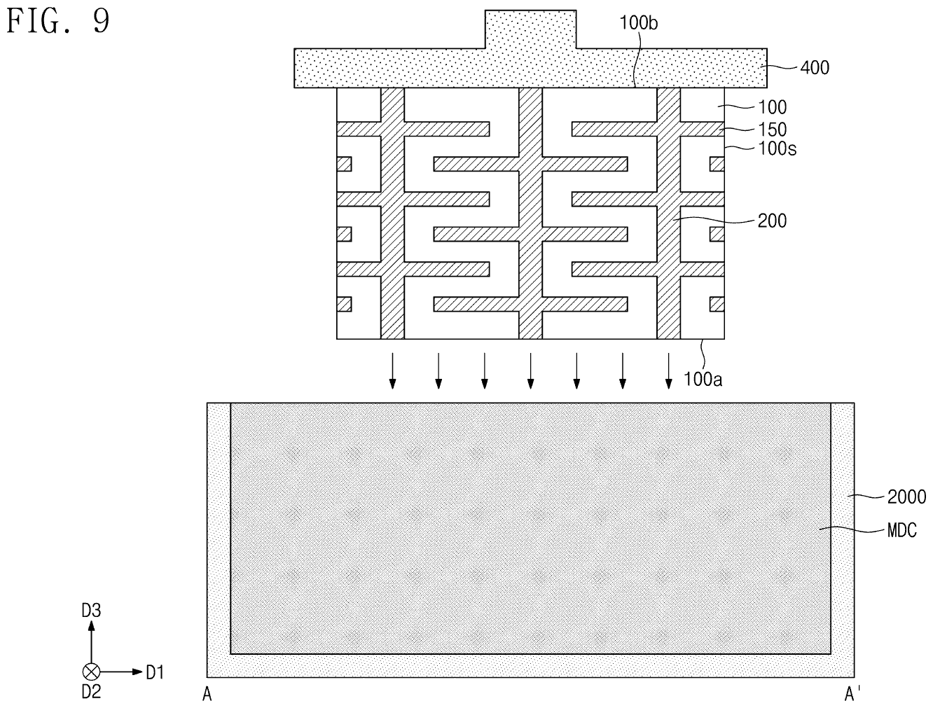

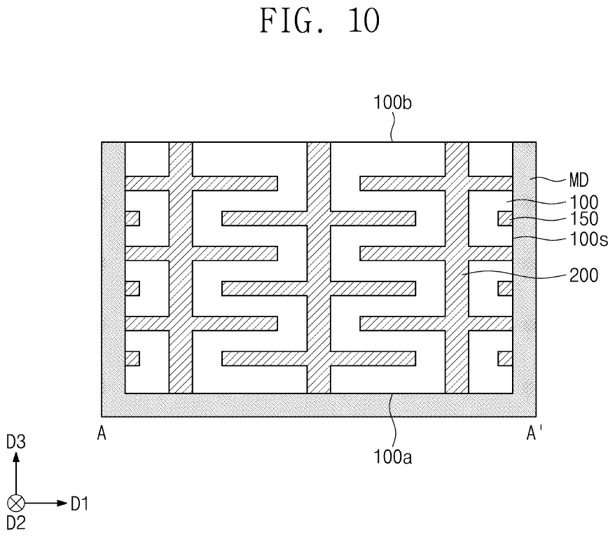

Referring to FIG. 9, a mold 2000 including (or filled with) molding powder MDC may be provided to form the molding layer MD. The molding powder MDC may be in a molten state obtained by a heat treatment process or the like.

Thereafter, a holding frame 400 may be attached to the second surface 100b of the dielectric 100 formed in FIG. 8. The holding frame 400 and the dielectric 100 may be moved in the third direction D3 so that the dielectric 100 is in contact with the molding powder MDC in the mold 2000. Through the contact process, the molding powder MDC may contact the first surface 100a and the side surfaces 100s of the dielectric 100. The molding powder MDC may not contact the second surface 100b of the dielectric 100 to which the holding frame 400 is attached.

Referring to FIG. 10, the mold 2000 and the holding frame 400 may be removed, and the molding powder MDC may be hardened (e.g., after cooling) to form a molding layer MD. The molding layer MD may contact and cover the first surface 100a and the side surfaces 100s of the dielectric 100. When the holding frame 400 is removed from the dielectric 100, the second surface 100b of the dielectric 100 may be exposed.

Thereafter, first connection pads 201 and first connection terminals 202 may be attached on the second surface 100b of the dielectric 100 and external electrodes 200 to form the multilayer ceramic capacitor 1 shown in FIG. 2.

The method of manufacturing a multilayer ceramic capacitor, according to some example embodiment of the inventive concepts, may include forming the external electrode penetrating the dielectric and forming the molding layer on all surfaces except one surface of the dielectric. Forming the external electrode may include forming the via hole penetrating the dielectric, filling the internal space of the via hole with the conductive material, and drying the conductive material. Since the conductive material forming the external electrode is dried before forming the molding layer, a reliable (e.g., stable) connection may be obtained between the connection pad and the external electrode. In addition, because the process includes forming the molding layer by attaching the holding frame to one surface of the dielectric and covering only some of the surfaces of the dielectric with the molding layer, process yield of the multilayer ceramic capacitor may be improved.

The multilayer ceramic capacitor, according to some example embodiments of the inventive concepts, may include the dielectric 100, the internal electrodes 150, the external electrode 200 penetrating the internal electrodes 150, and the molding layer MD. The molding layer MD may cover the surfaces of the dielectric 100. As a result, the water resistance or moisture resistance, along with thermal resistance and mechanical resistance, of the multilayer ceramic capacitor may be improved. The reliability of the multilayer ceramic capacitor may also be improved.

While several embodiments have been provided in the present disclosure, it should be understood that the disclosed devices and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A multilayer ceramic electronic component, comprising:
a dielectric including a first surface, a second surface opposite the first surface, and side surfaces connecting the first surface and the second surface, the dielectric including a plurality of stacked dielectric layers;
an internal electrode in the dielectric;
an external electrode penetrating the dielectric and the internal electrode; and
a molding layer covering the first surface of the dielectric and the side surfaces of the dielectric,
wherein the second surface of the dielectric is at a different level than or at a same level as a lower surface of the molding layer.

2. The multilayer ceramic electronic component of claim 1, further comprising:
a connection pad on the second surface of the dielectric; and
a connection terminal on the connection pad.

3. The multilayer ceramic electronic component of claim 2, wherein the connection pad is closer to the dielectric than the molding layer in a vertical direction.

4. The multilayer ceramic electronic component of claim 2, wherein the connection pad and the molding layer do not contact each other.

5. The multilayer ceramic electronic component of claim 1, wherein a lower surface of the external electrode is at a same level as the second surface of the dielectric.

6. The multilayer ceramic electronic component of claim 1, wherein the molding layer has a thickness of 1 μm to 100 μm.

7. The multilayer ceramic electronic component of claim 1, wherein the dielectric includes at least one of barium titanate or strontium titanate, and
wherein the internal electrode, the external electrode, or both the internal electrode and the external electrode include at least one of nickel, copper, and palladium.

8. The multilayer ceramic electronic component of claim 1, wherein at least one end of the external electrode contacts the molding layer.

9. The multilayer ceramic electronic component of claim 1, further comprising a protective layer on the second surface,
wherein a lower surface of the protective layer is at a same level as a lower surface of the molding layer.

10. The multilayer ceramic electronic component of claim 9, wherein the protective layer includes at least one of silicon nitride or silicon oxide.

11. The multilayer ceramic electronic component of claim 9, wherein the external electrode penetrates the protective layer.

12. The multilayer ceramic electronic component of claim 9, further comprising:
a connection pad on the protective layer; and
a connection terminal on the connection pad.

13. A multilayer ceramic electronic component, comprising:
a dielectric including a plurality of stacked dielectric layers;
an internal electrode in the dielectric;
an external electrode penetrating the dielectric and the internal electrode;
a connection pad on the external electrode; and
a molding layer on a plurality of surfaces of the dielectric,
wherein the connection pad and the molding layer are spaced apart from each other, and
wherein at least one surface of the plurality of surfaces of the dielectric does not include the molding layer.

14. The multilayer ceramic electronic component of claim 13, further comprising a protective layer on a lower surface of the dielectric,
wherein the connection pad contacts the external electrode and the protective layer.

15. The multilayer ceramic electronic component of claim 14, wherein an upper surface of the protective layer is at a higher level than a lower surface of the molding layer.

16. The multilayer ceramic electronic component of claim 14, wherein the molding layer contacts side surfaces of the protective layer.

17. An electronic device, comprising:
a package substrate; and
a semiconductor chip and a multilayer ceramic electronic component on the package substrate and spaced apart from each other in a first direction parallel to an upper surface of the package substrate,
wherein the multilayer ceramic electronic component includes:
a dielectric including a plurality of stacked dielectric layers;
an internal electrode in the dielectric;
an external electrode penetrating the dielectric and the internal electrode;
a connection pad on the external electrode and the dielectric;
a connection terminal on the connection pad; and
a molding layer on the dielectric, and
wherein the molding layer covers a plurality of surfaces of the dielectric except for a surface including the connection pad.

18. The electronic device of claim 17, wherein the molding layer has a thickness of 1 μm to 100 μm.

19. The electronic device of claim 17, wherein the multilayer ceramic electronic component further includes a plurality of external electrodes in the first direction and in a second direction parallel to the upper surface of the package substrate, and
wherein the second direction is perpendicular to the first direction.

20. The electronic device of claim 17, wherein the dielectric includes at least one of barium titanate or strontium titanate, and
wherein the internal electrode, the external electrode, or both the internal electrode and the external electrode include at least one of nickel, copper, and palladium.
